(19) United States
(12) Patent Application Publication
(10) Pub. No.: US 2025/0247705 A1
(43) Pub. Date: Jul. 31, 2025

(54) METHOD FOR PREVENTING VOICEMAIL AND MESSAGE INBOX FLOODING WITHIN MOBILE NETWORKS

(71) Applicant: T-Mobile USA, Inc., Bellevue, WA (US)

(72) Inventor: Bikash Agarwal, Bothell, WA (US)

(21) Appl. No.: 18/423,935

(22) Filed: Jan. 26, 2024

(51) Int. Cl. H04W 12/122; H04M 3/533

(52) U.S. Cl. CPC H04W 12/122; H04M 3/533; H04M 2203/6027

(57) ABSTRACT

Techniques and architecture are described for preventing bad actors or scammers from flooding voicemail, as well as SMS/MMS message inboxes, of mobile devices associated with users of mobile networks. A server/database may determine if messages and calls are from a bad actor or scammer. Thus, when a mobile originating (MO) device originates a signal for sending to a mobile terminating (MT) device utilizing one or more mobile networks, the components of one of the mobile networks may query the server/database to determine if the signal, e.g., phone call or message, is from a scammer. If the signal is a call from a scammer, an announcement may be provided to the MO device that the MO device is attempting to reach is busy. In the situation where the signal is a message, (e.g., a SMS or a MMS message), a notification may be provided to the MO device indicating delivery failure.

### BACKGROUND

Scam calls and robocalls, which may include pre-recorded and/or autodialed calls, are unwelcome to many mobile device users. User-defined call blocking using original equipment manufacturer (OEM) native features can be used to block calls from known numbers.

Currently, when a user of a mobile device wishes to block particular callers, e.g., robocallers or scammers, the only option is to save a call from a particular caller in the call history log of the mobile device into the user's contact library. Then, in the menu for the contact library, an option may be presented for blocking the particular caller, e.g., the particular phone number. Future calls from the particular number are thus blocked by the mobile device in future instances. However, this can be cumbersome for the user to block unwanted calls from various numbers and can be unreliable.

Today, bad actors or “scammers” attempt to flood mobile network phone mailboxes, e.g., voicemail, associated with a user's mobile device and/or short message service (SMS) and/or multimedia message service (MMS) messaging inboxes. The scammers often are attempting to get the user's attention in hopes of scamming the user out of money and/or property. The flooding of the voicemail and/or the message inboxes is very inconvenient for the users and may even be problematic.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is an example block diagram of an architecture for an example arrangement, according to some implementations.

FIG. 2 is flow diagram for preventing voicemail and message inbox flooding within mobile networks, according to some implementations.

FIG. 3 is a flow diagram illustrating an example process for preventing voicemail and message inbox flooding within mobile networks, according to some implementations.

FIG. 4 schematically illustrates a component level view of an example electronic device configured for use with the techniques and architecture described herein, according to some implementations.

FIG. 5 schematically illustrates a component level view of a server configured for use with the techniques and architecture described herein, according to some implementations.

### DETAILED DESCRIPTION

Described herein are techniques and architecture for preventing bad actors or scammers from flooding voice mail boxes, as well as SMS/MMS message inboxes, of mobile devices associated with users of mobile networks. More particularly, a mobile network operator may offer a service to users and if a user subscribes, e.g., registers with the service, a server may determine if messages and calls are from a bad actor, e.g., a scammer. With such a service, when a mobile originating (MO) device originates a signal for sending to a mobile terminating (MT) device utilizing one or more mobile networks, the components of one of the mobile networks may query the server database to determine if the signal, e.g., phone call or message, is from a scammer. If the call is from a scammer, the service may provide an announcement to the MO device, e.g., an announcement indicating that the number (e.g., the number of the MT device) that the MO device is attempting to reach is busy. In the situation where the signal is a message, (e.g., a SMS or a MMS message), instead of an announcement, a notification may be sent back to the MO device indicating delivery failure.

Thus, a MO device may initiate a signal that is directed to a mobile terminating number, i.e., the phone number, of a MT device. The MO device may be part of a first mobile network. The signal may be directed to one or more components of the first mobile network. The one or more components may then forward the signal to one or more components of a second mobile network within which the MT device is operated. As is known, the first mobile network and the second mobile network may be the same mobile network. The one or more components of the second mobile network may utilize an identifier of the MO device (e.g., the mobile originating number, i.e, the phone number of the MO device) and check with a server/scammer database to see if the identifier is associated with a known, or at least likely, scammer.

If the identifier is associated with a scammer, then if the signal is a phone call, the one or more components of the second mobile network may provide an announcement to the MO device that the MT device is busy. The one or more components of the second mobile network do not forward the phone call to a voicemail box associated with MT device.

In the situation where the number is associated with a scammer (or at least likely a scammer) and the signal is one of a SMS message or a MMS message, then the one or more components of the second mobile network may drop the signal and send a response back to the MO device indicating delivery failure.

In configurations, the user of the MT device may indicate that the identifier (e.g., phone number) is not a scammer or bad actor with respect to that user. For example, if the number is associated with a salesperson and the user does actually correspond and interact with that salesperson, then the user may indicate such to the service and the signal will be allowed to proceed to the MT device. The user of the MT device may answer the call, the call may be forwarded to a voicemail box, or, in the situation where the signal is a SMS message or a MMS message, the SMS message or MMS message may proceed to the MT device.

In configurations, a user (mobile network subscriber) has flexibility for selecting a call forwarding type from among several call forwarding types. The call forwarding feature may be active for different scenarios. During roaming, the user may lose the signal of the mobile network within which he is roaming. Thus, the user may want to set the call forwarding type such that phone calls may be forwarded to a landline number associated with the user if the user's mobile device is unreachable. Following is the list of example call forwarding types.

For unconditional call forwarding, if the call forwarding or call diverting for unconditional is set, all incoming calls will be forwarded to another number. The calls will be forwarded even if the mobile subscriber is online. Unconditional call forwarding is useful when one knows the original phone will not be used. For example, in a situation where a user has purchased a new number and wants to update the new number to all of their contacts, but also does not want to lose the calls from the older phone number unconditional call forwarding may be used to forward calls from the old number to another number, e.g., the new number.

For conditional call forwarding, when call forwarding is enabled, call diverting depends on subscriber status. Following are example conditional call diversion scenarios.

For call forwarding busy, a mobile user is talking to another person. In this case, the status of the user is busy. At a single time, the user can receive only one call. If the call forwarding busy is not active, the new call will disconnect.

For call forwarding is not reachable, when mobile phones get disconnected from the network and call forwarding is not reachable is set, then the number to which calls are to be forwarded will start ringing.

For call forwarding no answer, the phone keeps ringing for some time for an incoming call and the call is not picked up. In this case, this call forwarding comes into the picture. If a mobile subscriber has activated this call forwarding, then after ringing for some time, the call is forwarded to the number to which calls are to be forwarded.

Thus, if the MT device does not answer, then, depending upon call forwarding scenarios, the signal may be forwarded to voicemail and/or the announcement may be provided to the MO device. Additionally, if the user associated with the MT device has indicated that the user associated with the MO device is not a scammer with respect to the user of the MT device, then the call may be answered by the user of the MT device or the call may be routed to voicemail. Additionally, if the user of the MT device is a scammer or at least a likely scammer, then the announcement may be forwarded to the MT device. In the case of a message, the signal, e.g., message from the MT device may be dropped and a delivery failure message may be provided to the MT device.

Accordingly, as an example, a method comprises receiving, at a mobile telephony application server of a network from a mobile originating number, an incoming signal directed to a mobile terminating number and querying, by the mobile telephony application server, a scam database of the network. The method also comprises based at least in part on the querying, determining that the mobile originating number at least likely represents a scammer entity and based at least in part on the mobile originating number at least likely representing the scammer entity, one of (i) blocking the incoming signal and providing a message to the mobile originating number that the incoming signal is not accepted by the mobile terminating number or (ii) forwarding the incoming signal to a voicemail database associated with the mobile terminating number.

In configurations, the incoming signal is a telephone call and the message comprises an audio announcement.

In configurations, the incoming signal is one of a short message service (SMS) message or a multimedia message service (MMS) message and the message comprises one of a SMS message or a MMS message.

In configurations, the method further comprises receiving, from a device associated with the mobile terminating number, a code indicating the mobile originating number is not a scammer entity with respect to the mobile terminating number and forwarding the incoming signal to the mobile terminating number.

In configurations, the incoming signal comprises a telephone call and the method further comprises based at least in part on non-answering of the telephone call, forwarding the telephone call to a voicemail database.

In configurations, the incoming signal comprises a telephone call, an unconditional call forwarding status is set for the mobile terminating number and the method further comprises forwarding the telephone call to another number.

In some configurations, the another number is a landline number.

In some configurations, the another number is another mobile terminating number.

In some configurations, the incoming signal comprises a telephone call, a conditional call forwarding status is set for the mobile terminating number and the method further comprises based at least in part on the mobile terminating number being busy, forwarding the telephone call to a voicemail database.

In some configurations, the incoming signal comprises a telephone call, a call forwarding not reachable status is set for the mobile terminating number and the method further comprises based at least in part on a forwarding receiving number being busy, at least one of (i) forwarding the telephone call to the mobile terminating number or (ii) forwarding the telephone call to a voicemail database.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

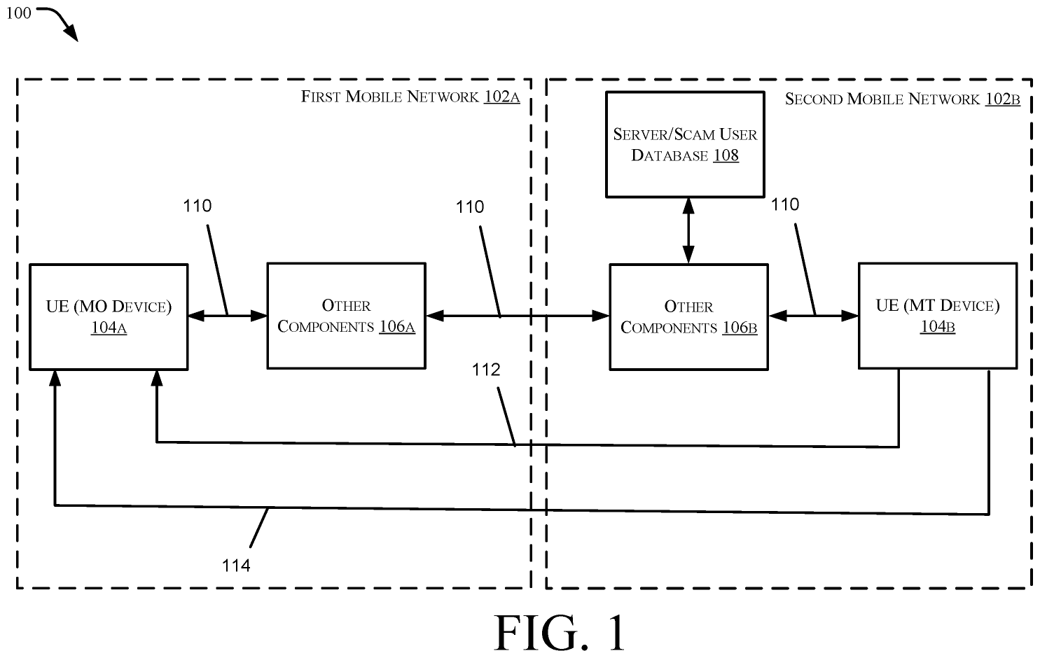

FIG. 1 schematically illustrates an example arrangement 100 of architecture for preventing voicemail and message inbox flooding within mobile networks. The example arrangement includes a first mobile network 102a and a second mobile network 102b. A first user equipment (UE) 104a is included in the first mobile network 102a and may serve as a mobile originating (MO) device as will be described herein in some examples. A second UE 104b is included in the second mobile network 102b and may serve as a mobile terminating (MT) device as will be described herein in some examples.

The first mobile network 102a further includes additional components 106a and the second mobile network 102b includes additional components 106b. In configurations the first and second mobile networks are configured as IP Multimedia Core Network Subsystem (IMS) networks, and thus, as will be discussed further herein, the additional components 106a may be a Proxy-Call Session Control Function (P-CSCF)/Access Transfer Control Function (ATCF), a serving-CSCF (S-CSCF), an O-TAS (originating telephony application server), and a terminating telephony application server (T-TAS). The second mobile network 102b also includes a server/scam user database 108. As is known, the first and second mobile networks 102a, 102b may be the same, i.e., a single, mobile network, and thus, only a single set of additional components 106a or 106b may be included. Additionally, one or both of the first and second mobile networks 102a, 102b may be configured as a different type of network.

As previously noted, a mobile network operator may offer a service to users and if a user subscribes, e.g., registers with the service, the server/scam user database 108 may determine if messages and calls are from a bad actor, e.g., a scammer. With such a service, when a MO device, e.g., UE 104a, originates a signal 110 for sending to a MT device, e.g., UE 104b, utilizing one or more mobile networks, e.g., the first and second mobile networks 102a, 102b, the components 106b of the mobile network 102b may query the server/scam user database 108 to determine if the signal 110, e.g., phone call or message, is from a scammer. If the call is from a scammer, the service may provide an announcement 112 to the UE 104a, e.g., an announcement indicating that the number (e.g., the number of the UE 104b) that the UE 104a is attempting to reach is busy. In the situation where the signal 110 is a message, (e.g., a SMS or a MMS message), instead of an announcement 112, a notification or response 114 may be sent back to the UE 104a indicating delivery failure.

Thus, the UE 104a may initiate a signal 110 that is directed to the UE 104a. The UE 104a may be part of the first mobile network 102a. The signal 110 may be directed to one or more components 106a of the first mobile network 102a. The one or more components 106a may then forward the signal 110 to one or more components 106b of the second mobile network 102b within which the UE 104b is operated.

The one or more components 106b of the second mobile network 102b may utilize an identifier of the UE 104a (e.g., the phone number of the UE 104a) and check with the server/scammer database 108 to see if the identifier is associated with a known, or at least likely, scammer.

If the identifier is associated with a scammer, then if the signal 110 is a phone call, the one or more components 106b of the second mobile network 102b may provide the announcement 112 to the UE 104a that the UE 104b is busy, unavailable, etc. The one or more components 106b of the second mobile network 102b do not forward the phone call to a voicemail box associated with the UE 104b.

In the situation where the number is associated with a scammer (or at least likely a scammer) and the signal 110 is one of a SMS message or a MMS message, then the one or more components 106b of the second mobile network 102b may drop the signal 110 and send the response 114 back to the UE 104b indicating delivery failure.

In configurations, the user associated with the UE 104b may indicate that the identifier (e.g., phone number) is not a scammer or bad actor with respect to that user. For example, if the number is associated with a salesperson and the user does actually correspond and interact with that salesperson, then the user may indicate such to the service and the signal 110 will be allowed to proceed to the UE 104b. The user of the UE 104b may answer the call, the call may be forwarded to a voicemail, or, in the situation where the signal 110 is a SMS message or a MMS message, the SMS message or MMS message may proceed to the UE 104b.

As previously noted, in configurations, a user (mobile network subscriber) has flexibility for selecting a call forwarding type from among several call forwarding types. The call forwarding feature may be active for different scenarios. During roaming, the user may lose the signal of the mobile network within which he is roaming. Thus, the user may want to set the call forwarding type such that phone calls may be forwarded to a landline number associated with the user if the user's mobile device is unreachable. Following is a list of example call forwarding scenarios.

For unconditional call forwarding, if the call forwarding or call diverting for unconditional is set, all incoming calls will be forwarded to another number. The calls will be forwarded even if the mobile subscriber is online. Unconditional call forwarding is useful when one knows the original phone will not be used. For example, in a situation where a user has purchased a new number and wants to update the new number to all of their contacts, but also does not want to lose the calls from the older phone number unconditional call forwarding may be used to forward calls from the old number to another number, e.g., the new number.

For conditional call forwarding, when call forwarding is enabled, call diverting depends on subscriber status. Following are example conditional call forwarding scenarios.

For call forwarding busy, a mobile user is talking to another person. In this case, the status of the user is busy. At a single time, the user can receive only one call. If the call forwarding busy is not active, the new call will disconnect.

For call forwarding is not reachable, when mobile phones get disconnected from the network and call forwarding is not reachable is set, then the number to which calls are to be forwarded will start ringing.

For call forwarding no answer, the phone keeps ringing for some time for an incoming call and the call is not picked up. In this case, this call forwarding comes into the picture. If the mobile subscriber has activated this call forwarding, then after ringing for some time, the call is forwarded to the number to which calls are to be forwarded.

Thus, if the UE 104b does not answer a phone call, then, depending upon call forwarding scenarios, the signal 110 may be forwarded to voicemail and/or the announcement 112 may be provided to the UE 104a. Additionally, if the user associated with the UE 104b has indicated that the user associated with the UE 104a is not a scammer with respect to the user of the UE 104a, then the call may be answered by the user of the UE 104a or the call may be routed to voicemail. Additionally, if the user of the UE 104a is a scammer or at least a likely scammer, then the announcement 112 may be forwarded to the UE 104a. In the case of a message (SMS or MMS), the signal 110, e.g., message from the UE 104a, may be dropped and a delivery failure response 114 may be provided to the UE 104a.

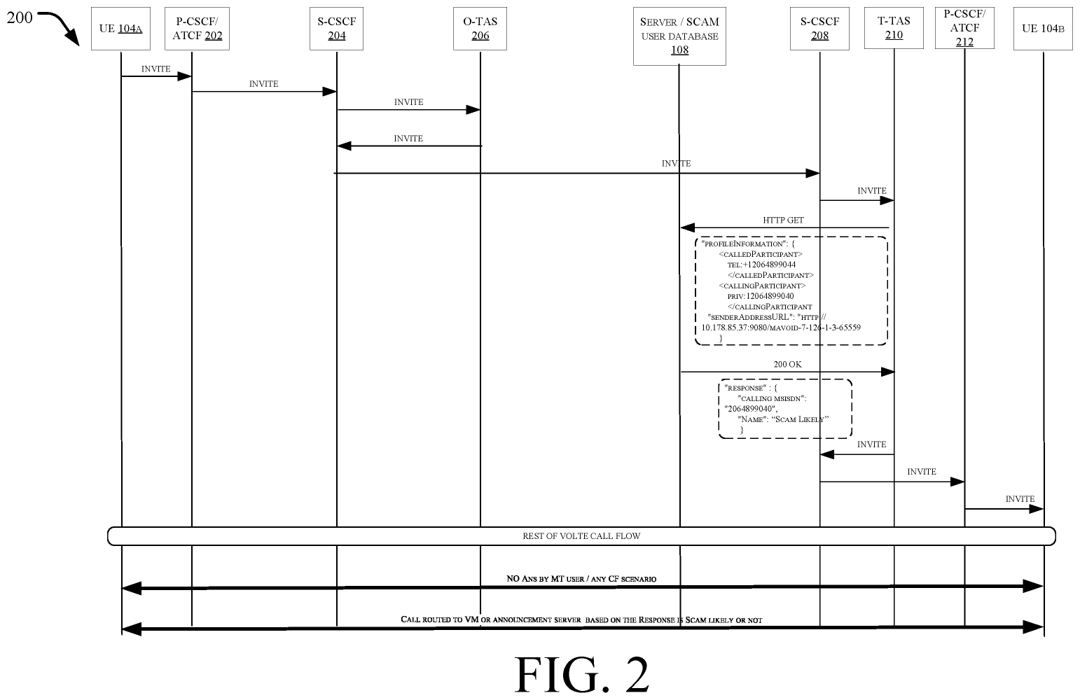

FIG. 2 schematically illustrates a flow diagram 200 for preventing voicemail and message inbox flooding within mobile networks. In configurations, the UE 104a (MO device) may send an invite message to the P-CSCF/ATCF 202 of the originating mobile network, e.g., the first mobile network 102a. The P-CSCF/ATCF 202 then sends an invite to the S-CSCF 204 of the originating network, which sends an invite to the O-TAS 206. The O-TAS 206 sends an invite message back to the S-CSCF 204 of the originating network.

The S-CSCF 204 sends an invite message to the S-CSCF 208 of the terminating mobile network, e.g., the second mobile network 102b. The S-CSCF 208 sends an invite message to the T-TAS 210 of the terminating network, which then sends an HTTP get message to the server/scam user database 108. The HTTP get includes profile information indicating that the UE 104b is part of a scam service provided by the terminating network and provides the sender (UE 104a) address to the server/scam database 108. The server/scam database 108 sends a 200 OK response message back to the T-TAS 210. The 200 OK response may indicate that the calling MSISDN of the UE 104b is in the database and that any signal from the UE 104a is likely or definitely a scam. Alternatively, the 200 OK response may indicate that the calling MSISDN of the UE 104b is not in the database and that any signal from the UE 104a is likely not a scam.

The T-TAS 210 then sends an invite message to the S-CSCF 212 of the terminating network, which sends an invite to the P-CSCF/ATCF 214 of the terminating network. The P-CSCF/ATCF 214 then sends an invite message to the UE 104b. As is known, several other steps are taken among the components for the VOLTE call flow. These steps are well known and thus are not described herein.

Thus, when a signal is forwarded from the UE 104a to the UE 104b, depending on call forwarding set by the user of the UE 104b and the 200 OK response from the server/scam database 108, if the signal is a phone call, the call may be forwarded to voicemail, to another number, or may be dropped and the announcement 112 may be provided to the UE 104a. If the signal is a message (SMS or MMS), the message may be forwarded the UE 104a, or may be dropped and the response 114 indicating delivery failure may be provided to the UE 104a.

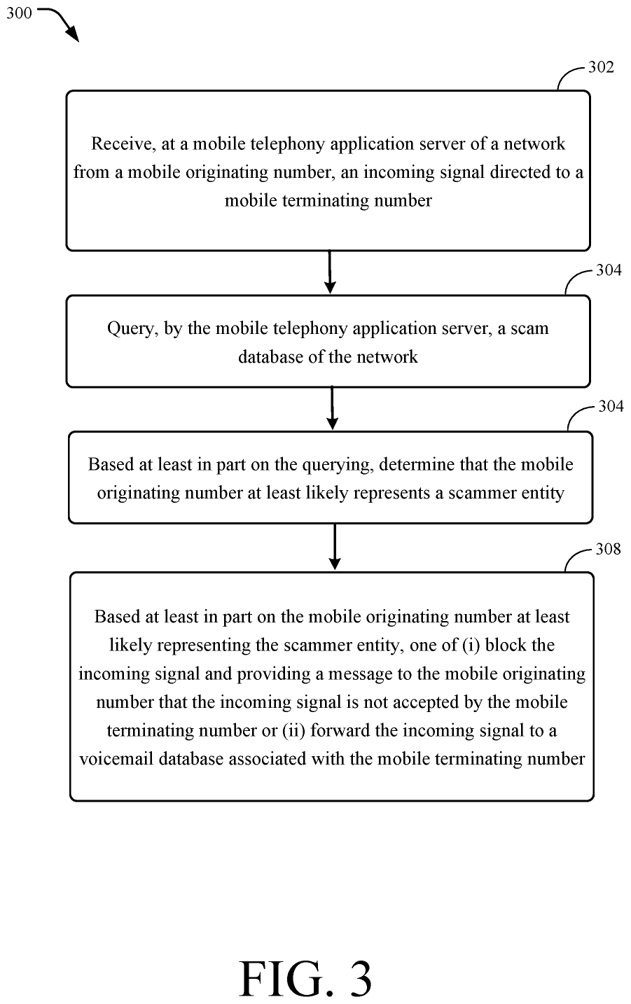

FIG. 3 is a flow diagram illustrating an example process, according to some implementations. The process is illustrated as a collection of blocks in a logical flow diagram, which represent a sequence of operations, some or all of which can be implemented in hardware, software, or a combination thereof. In the context of software, the blocks represent computer-executable instructions stored on one or more computer-readable media that, when executed by one or more processor(s), performs the recited operations. Generally, computer-executable instructions include routines, programs, objects, components, encryption, deciphering, compressing, recording, data structures and the like that perform particular functions or implement particular abstract data types.

The order in which the operations are described should not be construed as a limitation. Any number of the described blocks can be combined in any order and/or in parallel to implement the processes, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

FIG. 3 is a flow diagram illustrating an example process 300 for preventing voicemail and message inbox flooding within mobile networks.

At 302, a mobile telephony application server of a network receives, from a mobile originating number, an incoming signal directed to a mobile terminating number. For example, the UE 104a may initiate a signal 110 that is directed to the UE 104a. The UE 104a may be part of the first mobile network 102a. The signal 110 may be directed to one or more components 106a of the first mobile network 102a. The one or more components 106a may then forward the signal 110 to one or more components 106b of the second mobile network 102b within which the UE 104b is operated.

At 304, the mobile telephony application server queries a scam database of the network. For example, the one or more components 106b of the second mobile network 102b may utilize an identifier of the UE 104a (e.g., the phone number of the UE 104a) and check with the server/scammer database 108 to see if the identifier is associated with a known, or at least likely, scammer.

At 306, based at least in part on the querying, it is determined that the mobile originating number at least likely represents a scammer entity. At 308, based at least in part on the mobile originating number at least likely representing the scammer entity, one of (i) blocking the incoming signal and providing a message to the mobile originating number that the incoming signal is not accepted by the mobile terminating number or (ii) forwarding the incoming signal to a voicemail database associated with the mobile terminating number, is performed.

For example, If the identifier is associated with a scammer, then if the signal 110 is a phone call, the one or more components 106b of the second mobile network 102b may provide the announcement 112 to the UE 104a that the UE 104b is busy, unavailable, etc. The one or more components 106b of the second mobile network 102b do not forward the phone call to a voicemail box associated with the UE 104b.

In the situation where the number is associated with a scammer (or at least likely a scammer) and the signal 110 is one of a SMS message or a MMS message, then the one or more components 106b of the second mobile network 102b may drop the signal 110 and send the response 114 back to the UE 104b indicating delivery failure.

UEs 104a, 104b may be implemented as any suitable mobile computing device configured to communicate over a wireless and/or wireline network, including, without limitation, a mobile phone (e.g., a smart phone), a tablet computer, a laptop computer, a portable digital assistant (PDA), a wearable computer (e.g., electronic/smart glasses, a smart watch, fitness trackers, etc.), a networked digital camera, and/or similar mobile devices. Although this description predominantly describes the UEs 104a, 104b as being “mobile” (i.e., configured to be carried and moved around), it is to be appreciated that the UEs 104a, 104b may represent various types of communication devices that are generally stationary as well, such as televisions, desktop computers, game consoles, set top boxes, Internet of Things (IoT) devices, and the like. In this sense, the terms “communication device,” “wireless device,” “wireline device,” “mobile device,” “computing device,” and “user equipment (UE)” may be used interchangeably herein to describe any communication device capable of performing the techniques described herein. Furthermore, the UEs 104a, 104b may be capable of communicating over wired networks, and/or wirelessly using any suitable wireless communications/data technology, protocol, or standard, such as Global System for Mobile Communications (GSM), Time Division Multiple Access (TDMA), Universal Mobile Telecommunications System (UMTS), Evolution-Data Optimized (EVDO), Long Term Evolution (LTE), Advanced LTE (LTE+), Generic Access Network (GAN), Unlicensed Mobile Access (UMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), High Speed Packet Access (HSPA), evolved HSPA (HSPA+), Voice over IP (VOIP), Voice over LTE (VOLTE), 5G, IEEE 802.1x protocols, WiMAX, Wi-Fi, and/or any future IP-based network technology or evolution of an existing IP-based network technology.

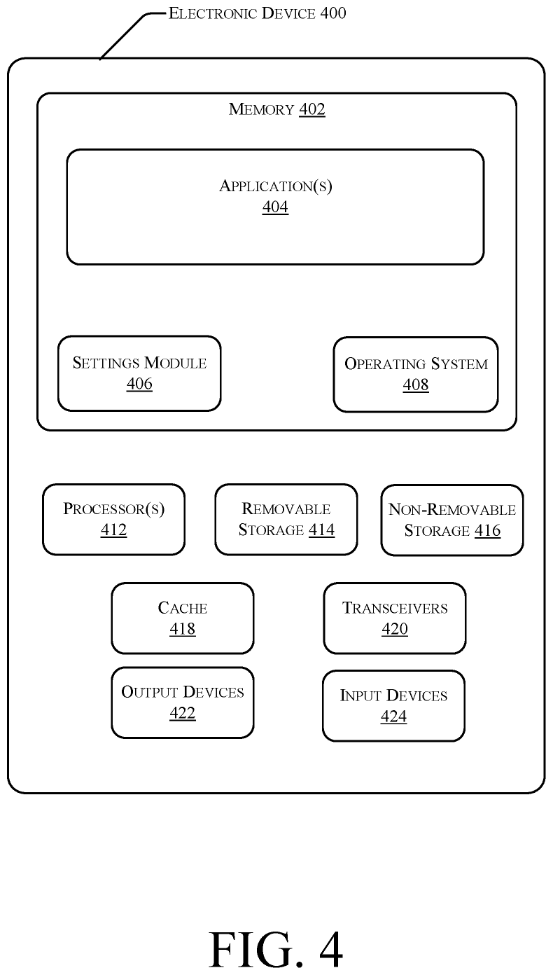

FIG. 4 schematically illustrates a component level view of a mobile device 400, such as UEs 104a, 104b, configured to function within wireless communication networks, e.g., mobile networks 102a, 102b. As illustrated, the mobile device 400 comprises a system memory 402, e.g., computer-readable media, storing application(s) 404, e.g., a call block/report application 426 that implements functions and UIs as described herein. Alternatively, the functions and UIs may be implemented, wholly or in part, via firmware (not illustrated). The mobile device also comprises a settings module 408, and an operating system 410. Also, the mobile device 400 includes processor(s) 412, a removable storage 414, a non-removable storage 416, cache 418, transceivers 420, output device(s) 422, and input device(s) 424. In various implementations, system memory 402 is volatile (such as RAM), non-volatile (such as ROM, flash memory, etc.) or some combination of the two. In some implementations, the processor(s) 412 is a central processing unit (CPU), a graphics processing unit (GPU), or both CPU and GPU, or any other sort of processing unit.

The mobile device 400 may also include additional data storage devices (removable and/or non-removable) such as, for example, magnetic disks, optical disks, or tape. Such additional data storage may include removable storage 414 and non-removable storage 416. Additionally, the mobile device 400 includes cache 418.

Non-transitory computer-readable media may include volatile and nonvolatile, removable and non-removable tangible, physical media implemented in technology for storage of information, such as computer readable instructions, data structures, program modules, or other data. System memory 402, removable storage 414, non-removable storage 416 and cache 418 are all examples of non-transitory computer-readable media. Non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other tangible, physical medium which can be used to store the desired information and which can be accessed by the mobile device 400. Any such non-transitory computer-readable media may be part of the mobile device 400. The processor(s) 412 may be configured to execute instructions, which may be stored in the non-transitory computer-readable media or in other computer-readable media accessible to the processor(s) 412.

In some implementations, the transceivers 420 include any sort of transceivers known in the art. For example, the transceivers 420 may include a radio transceiver that performs the function of transmitting and receiving radio frequency communications via an antenna (not shown). Also, or alternatively, the transceivers 420 may include wireless modem(s) to facilitate wireless connectivity with other computing devices. Further, the transceivers 420 may include wired communication components, such as an Ethernet port, for communicating with other networked devices.

In some implementations, the output devices 422 include any sort of output devices known in the art, such as a display (e.g., a liquid crystal display), speakers, a vibrating mechanism, or a tactile feedback mechanism. Output devices 422 also include ports for one or more peripheral devices, such as headphones, peripheral speakers, or a peripheral display.

In various implementations, input devices 424 include any sort of input devices known in the art. For example, input devices 424 may include a camera, a microphone, a keyboard/keypad, or a touch-sensitive display. A keyboard/keypad may be a push button numeric dialing pad (such as on a typical telecommunication device), a multi-key keyboard (such as a conventional QWERTY keyboard), or one or more other types of keys or buttons, and may also include a joystick-like controller and/or designated navigation buttons, or the like. The input devices 424 may be used to enter preferences of a user of the mobile device 400 to define how the user wishes certain calls from third parties to be handled by the wireless communication network, as previously described herein.

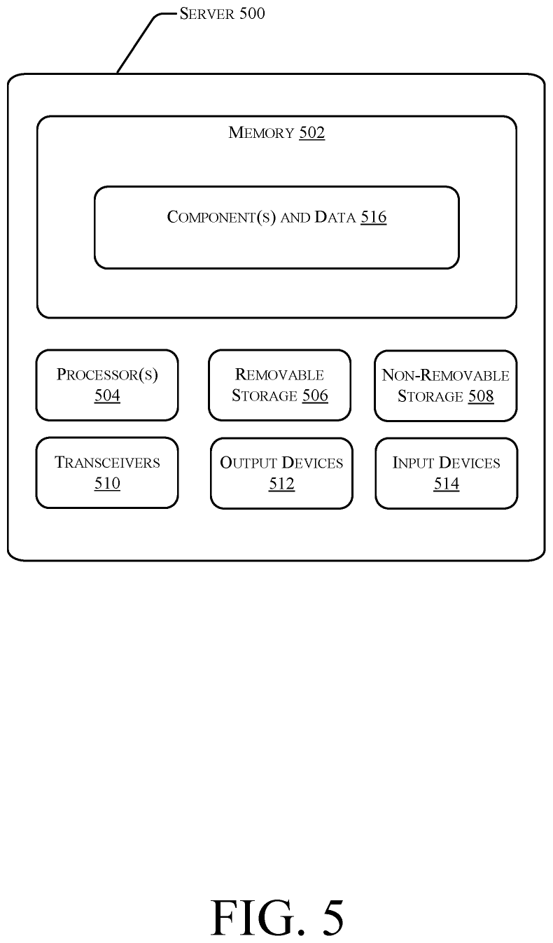

FIG. 5 illustrates a component level view of a server 500 configured for use within a wireless communication network, e.g., mobile networks 102a, 102b, in order to provide various services within the wireless communication network, according to the techniques described herein. For example, the server 500 may serve as a TAS or the server/scam database 108, e.g., one or more servers 500 may be configured to serve as a TAS or the server/scam database 108.

As illustrated, the server 500 comprises a system memory 502 that may store one or more components and/or applications and data 516 for interacting with mobile devices 500, e.g., UEs 104a, 104b, as described herein. For example, the one or more components and/or applications and data 516 may include the block list 120 and the report list 122. Also, the server 500 may include processor(s) 504, a removable storage 506, a non-removable storage 508, transceivers 510, output device(s) 512, and input device(s) 514.

In various implementations, system memory 502 is volatile (such as RAM), non-volatile (such as ROM, flash memory, etc.), or some combination of the two. In some implementations, the processor(s) 504 is a Central Processing Unit (CPU), a Graphics Processing Unit (GPU), or both CPU and GPU, or any other sort of processing unit.

The server 500 may also include additional data storage devices (removable and/or non-removable) such as, for example, magnetic disks, optical disks, or tape. Such additional storage is illustrated in FIG. 5 by removable storage 506 and non-removable storage 508. The one or more of the memory 502, the removable storage 506 and/or the non-removable 508 may include module(s) and data 516 (illustrated in the memory 502). The module(s) and data 516 may include instructions executable by, for example, the processor(s) 504.

Non-transitory computer-readable media may include volatile and nonvolatile, removable and non-removable tangible, physical media implemented in technology for storage of information, such as computer readable instructions, data structures, program modules, or other data. System memory 502, removable storage 506 and non-removable storage 508 are all examples of non-transitory computer-readable media. Non-transitory computer-readable media include, but are not limited to, RAM, ROM, EEPROM, flash memory or other memory technology, CD-ROM, Digital Versatile Disks (DVD) or other optical storage, magnetic cassettes, magnetic tape, magnetic disk storage or other magnetic storage devices, or any other tangible, physical medium which can be used to store the desired information and which can be accessed by the server 500. Any such non-transitory computer-readable media may be part of the server 500.

In some implementations, the transceivers 510 include any sort of transceivers known in the art. For example, the transceivers 510 may include wired communication components, such as an Ethernet port, for communicating with other networked devices. Also, or instead, the transceivers 510 may include wireless modem(s) to facilitate wireless connectivity with other computing devices. Further, the transceivers 510 may include a radio transceiver that performs the function of transmitting and receiving radio frequency communications via an antenna.

In some implementations, the output devices 512 include any sort of output devices known in the art, such as a display (e.g., a liquid crystal display), speakers, a vibrating mechanism, or a tactile feedback mechanism. Output devices 512 also include ports for one or more peripheral devices, such as headphones, peripheral speakers, or a peripheral display.

In various implementations, input devices 514 include any sort of input devices known in the art. For example, input devices 514 may include a camera, a microphone, a keyboard/keypad, a computer mouse, or a touch-sensitive display. A keyboard/keypad may be a push button numeric dialing pad (such as on a typical telecommunication device), a multi-key keyboard (such as a conventional QWERTY keyboard), or one or more other types of keys or buttons, and may also include a joystick-like controller and/or designated navigation buttons, or the like.

Some or all operations of the processes described above can be performed by execution of computer-readable instructions stored on a computer storage medium, as defined below. The term “computer-readable instructions” as used in the description and claims, include routines, applications, application modules, program modules, programs, components, data structures, algorithms, and the like.

Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like. Memory 604 and memory 502 are examples of computer storage media.

The computer storage media may include volatile memory (such as random access memory (RAM)) and/or non-volatile memory (such as read-only memory (ROM), flash memory, etc.). The computer storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient computer storage medium is an example of computer-readable media. Computer-readable media includes at least two types of computer-readable media, namely computer storage media and communications media. Computer storage media includes volatile and non-volatile, removable and non-removable media implemented in any process or technology for storage of information such as computer-readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. As defined herein, computer storage media do not include communication media.

The computer-readable instructions stored on one or more non-transitory computer storage media that, when executed by one or more processors, may perform operations described above with reference to FIGS. 1-3. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
receiving, at a mobile telephony application server of a network from a mobile originating number, an incoming signal directed to a mobile terminating number;
querying, by the mobile telephony application server, a scam database of the network;
based at least in part on the querying, determining that the mobile originating number at least likely represents a scammer entity; and
based at least in part on the mobile originating number at least likely representing the scammer entity, one of (i) blocking the incoming signal and providing a message to the mobile originating number that the incoming signal is not accepted by the mobile terminating number or (ii) forwarding the incoming signal to a voicemail database associated with the mobile terminating number.

2. The method of claim 1, wherein the incoming signal is a telephone call and the message comprises an audio announcement.

3. The method of claim 1, wherein the incoming signal is one of a short message service (SMS) message or a multimedia message service (MMS) message and the message comprises one of a SMS message or a MMS message.

4. The method of claim 1, further comprising:
receiving, from a device associated with the mobile terminating number, a code indicating the mobile originating number is not a scammer entity with respect to the mobile terminating number; and
forwarding the incoming signal to the mobile terminating number.

5. The method of claim 4, wherein the incoming signal comprises a telephone call and the method further comprises:
based at least in part on non-answering of the telephone call, forwarding the telephone call to a voicemail database.

6. The method of claim 4, wherein the incoming signal comprises a telephone call, an unconditional call forwarding status is set for the mobile terminating number and the method further comprises:
forwarding the telephone call to another number.

7. The method of claim 6, wherein the another number is a landline number.

8. The method of claim 6, wherein the another number is another mobile terminating number.

9. The method of claim 4, wherein the incoming signal comprises a telephone call, a conditional call forwarding status is set for the mobile terminating number and the method further comprises:
based at least in part on the mobile terminating number being busy, forwarding the telephone call to a voicemail database.

10. The method of claim 4, wherein the incoming signal comprises a telephone call, a call forwarding not reachable status is set for the mobile terminating number and the method further comprises:
based at least in part on a forwarding receiving number being busy, at least one of (i) forwarding the telephone call to the mobile terminating number or (ii) forwarding the telephone call to a voicemail database.

11. A system comprising:
one or more processors; and
one or more non-transitory storage media comprising instructions stored thereon, the instructions being executable by the one or more processors to cause the one or more processors to perform one or more actions comprising:
receiving, at a mobile telephony application server of a network from a mobile originating number, an incoming signal directed to a mobile terminating number;
querying, by the mobile telephony application server, a scam database of the network;
based at least in part on the querying, determining that the mobile originating number at least likely represents a scammer entity; and
based at least in part on the mobile originating number at least likely representing the scammer entity, one of (i) blocking the incoming signal and providing a message to the mobile originating number that the incoming signal is not accepted by the mobile terminating number or (ii) forwarding the incoming signal to a voicemail database associated with the mobile terminating number.

12. The system of claim 11, wherein the incoming signal is a telephone call and the message comprises an audio announcement.

13. The system of claim 11, wherein the incoming signal is one of a short message service (SMS) message or a multimedia message service (MMS) message and the message comprises one of a SMS message or a MMS message.

14. The system of claim 11, wherein the actions further comprise:
receiving, from a device associated with the mobile terminating number, a code indicating the mobile originating number is not a scammer entity with respect to the mobile terminating number; and
forwarding the incoming signal to the mobile terminating number.

15. The system of claim 14, wherein the incoming signal comprises a telephone call and the actions further comprise:
based at least in part on non-answering of the telephone call, forwarding the telephone call to a voicemail database.

16. The system of claim 14, wherein the incoming signal comprises a telephone call, an unconditional call forwarding status is set for the mobile terminating number and the actions further comprise:
forwarding the telephone call to another number.

17. The system of claim 14, wherein the incoming signal comprises a telephone call, a conditional call forwarding status is set for the mobile terminating number and the actions further comprise:
based at least in part on the mobile terminating number being busy, forwarding the telephone call to a voicemail database.

18. The system of claim 14, wherein the incoming signal comprises a telephone call, a call forwarding not reachable status is set for the mobile terminating number and the actions further comprise:
based at least in part on a forwarding receiving number being busy, at least one of (i) forwarding the telephone call to the mobile terminating number or (ii) forwarding the telephone call to a voicemail database.

19. One or more non-transitory storage media comprising instructions stored thereon, the instructions being executable by one or more processors to perform actions comprising:
receiving, at a mobile telephony application server of a network from a mobile originating number, an incoming signal directed to a mobile terminating number;
querying, by the mobile telephony application server, a scam database of the network;
based at least in part on the querying, determining that the mobile originating number at least likely represents a scammer entity; and
based at least in part on the mobile originating number at least likely representing the scammer entity, one of (i) blocking the incoming signal and providing a message to the mobile originating number that the incoming signal is not accepted by the mobile terminating number or (ii) forwarding the incoming signal to a voicemail database associated with the mobile terminating number.

20. The one or more non-transitory storage media of claim 19, wherein the actions further comprise:
receiving, from a device associated with the mobile terminating number, a code indicating the mobile originating number is not a scammer entity with respect to the mobile terminating number; and
forwarding the incoming signal to the mobile terminating number.
